(19) United States
(12) Patent Application Publication
(10) Pub. No.: US 2013/0181793 A1
(43) Pub. Date: Jul. 18, 2013

(54) ELECTRICAL CONTACTOR

(71) Applicants: Andreas Bauer, Kirchberg (DE); Rainer Junck, Munchen (DE); Markus Stoffels, Munchen (DE)

(72) Inventors: Andreas Bauer, Kirchberg (DE); Rainer Junck, Munchen (DE); Markus Stoffels, Munchen (DE)

(73) Assignee: Schaltbau GmbH, Muenchen (DE)

(21) Appl. No.: 13/812,830

(22) PCT Filed: Apr. 28, 2011
(86) PCT No.: PCT/EP2011/002146

§ 371 Date: Apr. 3, 2013

(30) Foreign Application Priority Data
Jul. 28, 2010 (DE) 102010032456.6

(51) Int. Cl. H01H 50/62

(52) U.S. Cl. CPC H01H 50/62
USPC 335/133

(57) ABSTRACT

Disclosed is an electrical contactor, comprising main contacts and secondary contacts, an armature provided for actuating the main contact bridges and secondary contact bridges, and means for restoring the armature from an intermediate position or end position to an initial position, wherein a precharging coil and a pick-up coil are provided in order to electromagnetically drive the armature. A coil yoke is arranged in such a way that the magnetic force acting on the armature due to the magnetic field produced by the precharging coil is greater in the end position of the armature than in the intermediate position when equal current is provided to the precharging coil, wherein said magnetic force corresponds to the restoring force of the means for restoring the armature to the initial position in the intermediate position of the armature and is greater than the restoring force in the end position of the armature.

The invention relates to an electrical contactor according to the preamble of independent claim 1. Such a contactor comprises a housing, at least two fixed main contacts and one main contact bridge, at least two fixed secondary contacts and one secondary contact bridge, wherein the main contacts, the secondary contacts and the contact bridges are arranged in the housing. Such an electric contactor further comprises an armature provided for actuating the main contact bridge and secondary contact bridge. In a first switch position, both the main contacts and the secondary contacts are open, wherein the armature is located in an initial position. In a second switch position, the secondary contacts are closed and the main contacts are open. Thereby, the armature is in an intermediate position. In a third switch position, both the secondary contacts and the main contacts are closed, wherein the armature is in an end position. The contactor further comprises at least one coil to which current can be provided in order to electromagnetically drive the armature, wherein the magnetic force acting on the armature due to the magnetic field produced by the coil effectuates the drive of the armature. In addition, a coil yoke, which forms a magnetic yoke, is provided. Finally, such a contactor also comprises means for restoring the armature to the initial position. A restoring force acting on the armature through the means is directed opposite the magnetic force produced by the magnetic field, and is also greater in the end position of the armature than in the intermediate position.

Such contactors are used to precharge for instance a capacitor via the secondary contacts, before the main contacts are closed. For example, this is necessary if, through a contactor, a direct current is switched to a converter or an inverter. Usually, a large capacitor is located at the entryway of such a converter or inverter. If the direct current is switched directly to the capacitor through the main contacts, a short-circuit current practically flows for a certain period of time; i.e. for so long until the charge of the capacitor produces resistance. The time span in which this high short-circuit current flows depends on the capacitance of the capacitor and the internal resistance of the source, along with the resistance of the leads. The high current is detrimental to the main contacts, and can lead to the fusing of the main contacts. In any event, the service life will be reduced. The state of the art is to precharge the capacitor through secondary contacts and through a resistor, and then to close the main contacts.

A contactor of the type specified above is known from DE 31 05 117 A1. With this contactor, secondary contacts are designed as preleading contacts. This means that, upon the switch-on procedure, through the movement of the armature from the initial position to the end position, the secondary contacts are initially closed, such that, for example, a capacitor can be briefly charged through the secondary contacts and through a resistor connected to the secondary contacts. However, the armature is moved immediately from the coil driving it further into the end position, such that the main contacts are also closed a short time after closing the secondary contacts. A similar contactor is also known from DE 103 15 243 B3. However, in contrast to the contactor known from DE 31 05 117 A1, upon the switch-off procedure here, the secondary contacts are initially opened, and the main contacts are opened afterwards.

For the contactors known from prior art, it is common that the amount of time in which the secondary contacts have already been closed before the main contacts are closed cannot vary. The armature that, on its path from an initial position to the end position, initially closes the secondary contacts and then the main contacts, for all intents and purposes switches from the initial position to the end position. An intermediate position of the armature in which only the secondary contacts are closed cannot be maintained in a controlled manner over a long period of time. This has the disadvantage that the closure of the main contacts cannot be made dependent on what intensity of current arises, for example after the closure of the secondary contacts. A further disadvantage of the contactors of the type specified above, known from prior art, is that the electromagnetic coil to drive the armature must be dimensioned relatively large in order to move the armature from the initial position to the end position. That is, the power consumption of the electromagnetic coil to drive the armature is relatively large, such that the contactors known from prior of art exhibit a high power dissipation, even if the coil holds the armature only in the end position.

Therefore, the task of the present invention is to specify a possibility for a contactor of the type specified above to hold the armature in the intermediate position in a controlled manner, in which only the secondary contacts are closed. It is also the task of the present invention to specify a contactor of the type specified above with significantly reduced power dissipation.

The task is solved under the invention through the features of claim 1. Accordingly, a solution of the task under the invention exists if a precharging coil and a pick-up coil to which current can be provided in addition to or independently of the precharging coil are provided for the electromagnetic drive of the armature, wherein the coil yoke is arranged in such a way that the magnetic force acting on the armature due to the magnetic field produced by the precharging coil is greater in the end position of the armature than in the intermediate position when equal current is provided to the precharging coil, wherein said magnetic force corresponds to the restoring force in the intermediate position of the armature and is greater than the restoring force in the end position of the armature, and wherein the precharging coil is provided in order to move the armature from the initial position to the intermediate position and to retain the armature in the end position, and furthermore the pick-up coil is provided in order to move the armature from the intermediate position to the end position.

The invention offers the advantage that the armature can be held in a controlled manner in the intermediate position, in which only the secondary contacts, but not the main contacts, are closed. Thus, through suitable measuring electronics, it is possible to determine, for example, whether there is a short circuit in the electrical circuit closed by the secondary contacts. If there is a short circuit, the further switch-on procedure can be interrupted. Another advantage of the present invention is that the armature can be held by the low-power precharging coil in the end position, at which both the secondary contacts and the main contacts are closed, such that the power dissipation of the contactor is relatively low. Upon the switch-on procedure, the pick-up coil must be switched on only for a short time. The pick-up coil is usually more powerfull, but operates only for a short time.

Further embodiments of the present invention comprise the subject matter of the subclaims.

Thus, in a preferred embodiment of the present invention, the pick-up coil is switched on in addition to the precharging coil to drive the armature from the intermediate position to the end position. Purely theoretically, it would also be possible to switch off the precharging coil to drive the armature from the intermediate position to the end position and only switch on the pick-up coil. Yet, in this case, the pick-up coil would have to be designed more powerful.

In a further preferred embodiment of the present invention, the precharging coil and the pick-up coil are arranged concentrically to one another. Thus, the magnetic field produced by the precharging coil can be enforced by the pick-up coil in an optimal manner. Preferably, the precharging coil and the pick-up coil enclose at least a part of the armature. Thus, a very large magnetic force can be exerted on the armature. In addition, this arrangement allows for a space-saving design.

In a further preferred embodiment of the present invention, the precharging coil and the pick-up coil are wound around one another, wherein the pick-up coil represents the outer winding. This facilitates a highly cost-effective and simple manufacture of the contactor.

If, in a further preferred embodiment of the present invention, the ohmic resistance of the pick-up coil is less than the ohmic resistance of the precharging coil, the power of the pick-up coil and thereby the magnetic force on the armature generated by the pick-up coil is so great that a fast and safe switch-on procedure can be guaranteed. Preferably, the pick-up coil is wound from a wire that is thicker than that of the precharging coil.

In a further preferred embodiment of the present invention, the means for restoring the armature into the initial position comprises a first spring, which is arranged between a first spring stop of the armature and a second spring stop connected with the housing and exerts a restoring force in each position of the armature between the initial position and the end position on the armature. The first spring ensures that the contactor is switched off as soon as the power supply of the coil is interrupted. Preferably, the means for restoring the armature into the initial position further comprises a second spring, which is shorter than the first spring and is likewise arranged between the first spring stop and the second spring stop. Thereby, when the armature is located between the initial position and a position close to the intermediate position, the second spring does not exert any force on the armature. When the armature is located between this position close to the intermediate position and the end position, a restoring force is exerted on the armature by the second spring. Thus, it is possible in a simple manner to increase the restoring force on the armature close to the intermediate position in a step, such that the precharging coil is not sufficient to move the armature from the intermediate position further into the end position. Preferably, the second spring is also harder than the first spring.

In a further preferred embodiment of the present invention, the first spring and the second spring are designed as spiral springs and are arranged concentrically to one another. This allows for a simple construction of the contactor under the invention. In a further preferred embodiment of the present invention, electrical resistors are linked with connectors of the secondary contacts in order to limit the intensity of current in an electrical circuit closed by the secondary contacts. Here, the resistors can be integrated into the housing of the contactor. It is also possible to interconnect the resistors with the contactor in an electrical circuit. The provision of the resistors allows for, for example, the precharging of a capacitor connected to the contactor.

In a further particularly preferred embodiment of the present invention, there is also an electronic system for turning on and turning off the precharging coil and pick-up coil, and for measuring and monitoring a current flowing through the secondary contacts. Preferably, the electronic system is provided in such a manner that the pick-up coil, if the intensity of current measured by the electronic system upon the switch-on procedure in the second switch position falls below a first threshold value, is switched on by the electronic system in addition to the precharging coil for a certain period of time, such that the armature moves from the intermediate position to the end position, wherein the precharging coil, if the intensity of current measured by the electronic system in the second switch position exceeds a second threshold value for a certain period of time, is switched off by the electronic system, such that the armature is moved by the restoring force into the initial position. The electronic system allows for the detection of a short circuit in the electrical circuit switched by the contactor, and prevents the main contacts from being closed in the presence of a short circuit.

In a further preferred embodiment of the present invention, the main contacts and the secondary contacts are essentially arranged side by side in one plane, such that it is aligned in a manner perpendicular to the direction of movement of the armature. This allows for an extremely compact design of the contactor.

In a further preferred embodiment of the present invention, the contactor also comprises a contact bridge support, on which the main contact bridges and the secondary contact bridges are arranged, wherein the contact bridge support is connected with the armature. Preferably, the main contact bridges and the secondary contact bridges are spring loaded on the contact bridge support using contact pressure springs. Through the contact pressure springs, the main contact bridges in the end position of the armature are pressed against the fixed main contacts, and the secondary contact bridges in the intermediate position and the end position of the armature are pressed against the fixed secondary contacts. The corresponding contacts are thereby closed in the respective position of the armature in a fixed and secured manner, such that an opening of the contacts through external mechanical stresses, such as vibrations arising in the operation of a vehicle, is prevented. Preferably, the contact pressure springs of the secondary contact bridges are longer than the contact pressure springs of the main contact bridges, wherein the distance between the secondary contacts and the secondary contact bridges in the first switch position is greater than the distance between the main contacts and the main contact bridges. Thus, it can be achieved in a simple manner that the secondary contacts in the intermediate position of the armature are closed, without the main contacts likewise being closed.

In a further particularly preferred embodiment of the present invention, the main contacts and the secondary contacts are arranged in the area of a common arc control device. Electric arcs particularly arise upon switching off, thus upon the opening of the contacts, and can lead to the fusing of the contacts. This effect can be avoided with an arc control device, which increases the service life of the contactor. A compact design is achieved through a common arc control device for the main contacts and the secondary contacts. The arc control device preferably comprises a control area with several arc interruption plates arranged in layers. Thereby, the effect of the arc control device can be improved if the control area is filled with an inert gas.

In a further particularly preferred embodiment of the present invention, the contactor is designed with two poles, and comprises four main contacts along with four secondary contacts. Thereby, each two of these contacts are closed by a contact bridge.

The following more specifically describes an embodiment of the present invention based on drawings.

The following is shown:

FIG. 1 a schematic front view of a contactor under the invention in a first switch position,

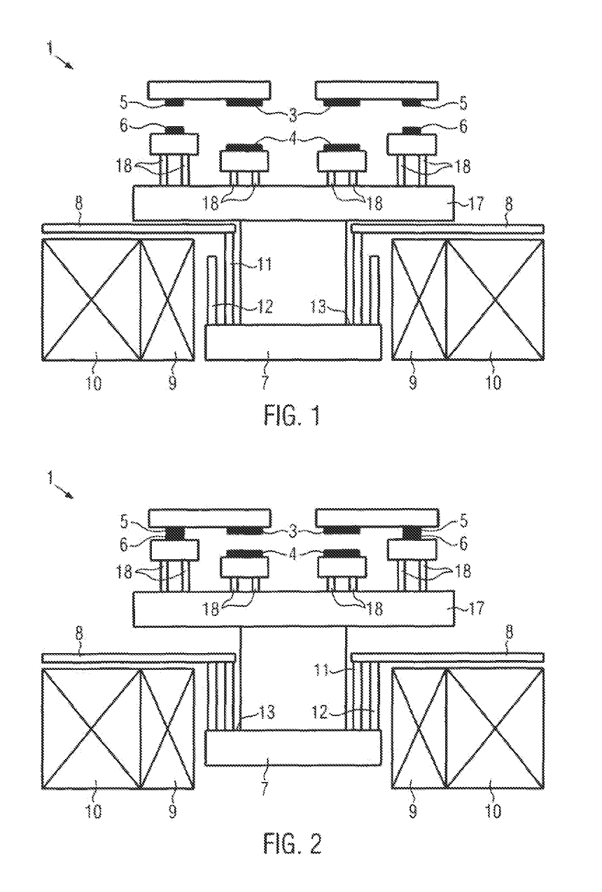

FIG. 2 the contactor under the invention from FIG. 1 in a second switch position,

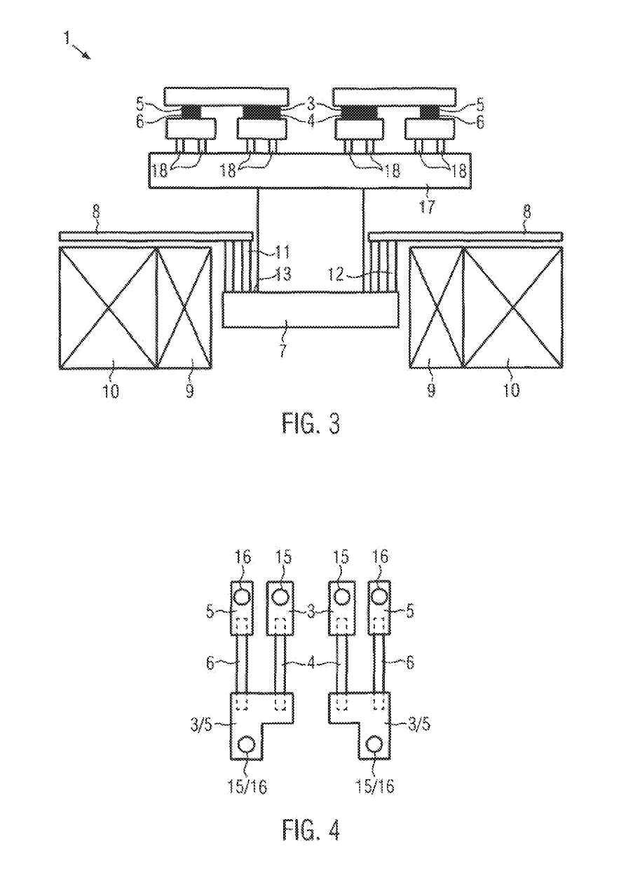

FIG. 3 the contactor under the invention from FIGS. 1 and 2 in a third switch position,

FIG. 4 a top view of the arrangement of contacts of the contactor under invention from FIGS. 1 to 3,

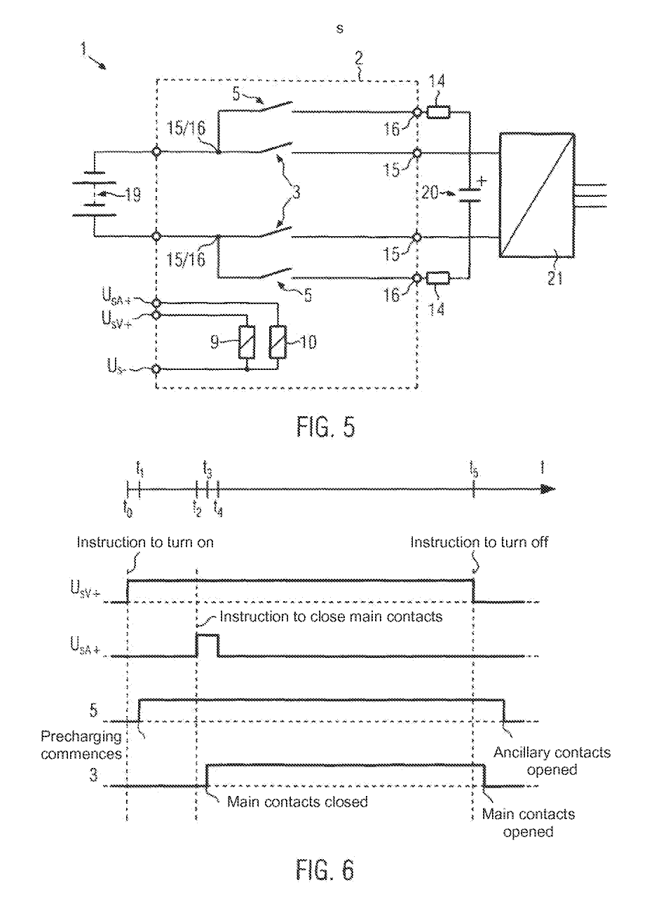

FIG. 5 the wiring diagram of a converter circuit with a contactor under the invention in accordance with FIGS. 1 to 4, and

FIG. 6 a diagram of the chronological sequence of the coil voltage of the precharging coil and the pick-up coil, along with the position of the main contacts and secondary contacts during the switch-on procedure and switch-off procedure.

For the following statements, the same reference symbols designate the same components.

FIG. 1 shows the schematic structure of a contactor under the invention in a front view. The contactor 1 comprises a housing that is not shown, in which all of the shown components are housed. The shown contactor is designed with two poles and comprises, for each pole, two main contacts 3 firmly connected with the housing and two secondary contacts 5 likewise firmly connected with the housing. Here, two main contacts 3 and two secondary contacts 5, as the case may be, in the image of FIG. 1 are arranged in succession, as can be seen in the schematic top view for the arrangement of the contacts in FIG. 4. A pair of main contacts 3 arranged in succession in FIG. 1 is assigned a main contact bridge 4, with the assistance of which each pair of main contacts 3 can be closed. Accordingly, each pair of secondary contacts 5 is assigned a secondary contact bridge 6. As can be seen from the top view in FIG. 4, the respective rear main contact 3 of a main contact pair possesses its own port 15. Likewise, the rear secondary contact 5 also possesses its own port 16. Each of the pairs of main contacts 3 closable by a main contact bridge is assigned a pair of secondary contacts 5, wherein a common port 15/16 is provided for the front main contacts and secondary contacts. Using contact pressure springs 18, the main contact bridges 4 along with the secondary contact bridges 6 are spring loaded on a contact bridge support 17, which is firmly connected to an armature 7. The armature 7 is used for actuating the main contact bridges and secondary contact bridges 4 and 6, and is driven by a precharging coil 9 and a pick-up coil 10. A coil yoke 8 serves as a magnetic yoke of the precharging coil 9 and the pick-up coil 10. The precharging coil 9 and the pick-up coil 10 are arranged concentrically to one another and enclose the armature 7. Two spiral springs 11 and 12 likewise arranged concentrically to one another are arranged between a stop 13 formed in steps of the armature 7 and the coil yoke 8, which serve to restore the armature 7 in the initial position of the armature presented in FIG. 1. Thereby, the armature in the initial position is pretensioned solely by the first spring 11 in the direction of the initial position.

When voltage is applied to the precharging coil 9, a magnetic field is produced by the precharging coil 9, which effectuates a magnetic force on the armature 7, such that the armature 7 together with the contact bridge support 17 is lifted upwards in an intermediate position, as shown in FIG. 2. This intermediate position of the armature 7, as shown in FIG. 2, corresponds to a second switch position of the contactor 1, in which the secondary contacts 5 are closed by a secondary contact bridge 6. In this second switch position, through their contact pressure springs, which are slightly longer than the contact pressure springs of the main contact bridges 4, the secondary contact bridges 6 are pressed against the secondary contacts 5. However, the main contact bridges 4 are, in the second switch position, spaced apart from the main contacts 3, such that the main contacts 3 are not closed. In the second switch position, the first spiral spring 11 is already somewhat compressed, wherein an increased restoring coil force is exerted on the armature 7 in the direction of the initial position of the armature shown in FIG. 1. In addition, the second spiral spring 12 in the second switch position shown in FIG. 2, through the shortened distance between the coil yoke 8 and the spring stop 13, is now also engaged, and likewise effectuates a restoring force on the armature 7. In the second switch position of the contactor 1 under the invention, as shown in FIG. 2, which corresponds to the intermediate position of the armature 7, the magnetic force acting from the precharging coil 9 on the armature 7 is in balance with the oppositely directed force, which is exerted on the armature 7 by the springs 11 and 12, and by the contact pressure springs 18 of the secondary contact bridges 6, which are already engaged. The second switch position of the contactor 1, as shown in FIG. 2, is thereby a stable switch position, as long as constant voltage is applied to the precharging coil 9.

If the pick-up coil 10 is then switched on in addition to the precharging coil 9, the armature 7 is lifted from the intermediate position, as shown in FIG. 2, to the end position, as shown in FIG. 3. In this end position of the armature 7, the contactor 1 under the invention is located in the third switch position, in which both the secondary contacts 5 and the main contacts 3 are closed. In this third switch position, the armature 7 comes very close to the coil yoke 8. As a result, a very large magnetic force is exerted on the armature 7 as soon as the third switch position is achieved; therefore, the pick-up coil 10 can be switched off again, since the magnetic field produced by the precharging coil 9 is sufficient to hold the armature 7 in its end position.

FIG. 5 shows the wiring diagram of a converter circuit with a contactor under the invention in accordance with FIGS. 1 to 4. The two poles of a direct current power source 19 are connected with a pair of assigned main contacts and secondary contacts with the common ports 15/16. As soon as the secondary contact 5 are closed in the second switch position of the contactor under the invention, a current flows through the resistors 14 into the external electrical circuit, through which the capacitor 20, which is connected upstream to the inverter 21, is charged. Using a suitable electronic system, the current that arises thereby can be measured and/or monitored. As soon as the current falls below a certain threshold value, the capacitor is thus sufficiently charged; the contactor 1 can be interconnected into the third switch position, in which the main contacts 3 are also closed. As a result, the resistors 14 are bridged, and almost no electricity flows through the secondary contacts 5. In FIG. 5, the housing of the contactor under the invention 1 is signified with the reference symbol 2.

FIG. 6 finally shows the chronological sequences of the voltage U_{SV} applied to the precharging coil, of the voltage U_{SA} applied to the pick-up coil and of the switching status of the secondary contacts 5 and the main contacts 3. The switch-on procedure commences at the point in time T₀; voltage is applied to the precharging coil 9. With a certain time offset, caused by the movement of the armature, the secondary contacts 5 are closed at the point in time T₁. At the point in time T₂, the pick-up coil is switched on in addition to the precharging coil for a short period of time. Given that the pick-up coil is switched on briefly until the point in time T₄, the armature is lifted into the end position, such that, at the point in time T₃, the main contacts 3 are also closed. After the closing of the main contacts, the pick-up coil can be switched off again, which is why the voltage U_{SA} applied to the pick-up coil again drops to 0. At the point in time T₅, the instruction to turn off is delivered, which accordingly also reduces the voltage U_{SV} applied to the precharging coil to 0. With the return springs, the armature 7 is brought back to its original position. Thereby, first the main contacts 3 are opened, and then the secondary contacts 5 are opened.

It should be noted that the contactor under the invention can also be used for alternating current applications, such as when there is a precharging. The contactor schematically shown in FIGS. 1 to 4 also possesses an arc control device, which is not shown, to control an arc that arises upon the switching off and/or opening of the main contacts and the secondary contacts.

1. Electrical contactor, comprising: a housing; at least two fixed main contacts and one main contact bridge; at least two fixed secondary contacts and one secondary contact bridge, wherein the main contacts, the secondary contacts and the contact bridges are arranged in the housing; an armature provided for actuating the main contact bridge and secondary contact bridge, wherein, in a first switch position, both the main contacts and the secondary contacts are open and the armature is located in an initial position, in a second switch position, the secondary contacts are closed and the main contacts are open and the armature is in an intermediate position, and, in a third switch position, both the secondary contacts and the main contacts are closed and the armature is in an end position; at least one coil to which current can be provided in order to electromagnetically drive the armature, wherein the magnetic force acting on the armature due to the magnetic field produced by the coil effectuates the drive of the armature; a coil yoke, which forms a magnetic yoke; and means for restoring the armature to the initial position, wherein a restoring force acting on the armature through the means is directed opposite the magnetic force produced by the magnetic field, and is also greater in the end position of the armature than in the intermediate position, characterized in that a precharging coil and a pick-up coil to which current can be provided in addition to or independently of the precharging coil are provided for the electromagnetic drive of the armature, wherein the coil yoke is arranged in such a way that the magnetic force acting on the armature due to the magnetic field produced by the precharging coil is greater in the end position of the armature than in the intermediate position when equal current is provided to the precharging coil, wherein said magnetic force corresponds to the restoring force in the intermediate position of the armature and is greater than the restoring force in the end position of the armature, and wherein the precharging coil is provided in order to move the armature from the initial position to the intermediate position and to retain the armature in the end position, and furthermore the pick-up coil is provided in order to move the armature from the intermediate position to the end position.

2. Contactor according to claim 1, characterized in that the pick-up coil is switched on in addition to the precharging coil to drive the armature from the intermediate position to the end position.

3. Contactor according to claim 1, characterized in that the precharging coil and the pick-up coil are arranged concentrically to one another and enclose at least a part of the armature.

4. Contactor according to claim 3, characterized in that the precharging and the pick-up coil are wound around one another, wherein the pick-up coil represents the outer winding.

5. Contactor according to claim 1, characterized in that the ohmic resistance of the pick-up coil is less than the ohmic resistance of the precharging coil.

6. Contactor according to claim 5, characterized in that the pick-up coil is wound from a wire that is thicker than that of the precharging coil.

7. Contactor according to claim 1, characterized in that the means for restoring the armature into the initial position comprises a first spring, which is arranged between a first spring stop of the armature and a second spring stop connected with the housing and exerts a restoring force in each position of the armature between the initial position and the end position on the armature.

8. Contactor according to claim 7, characterized in that the means further comprises a second spring, which is shorter than the first spring and is likewise arranged between the first spring stop and the second spring stop, wherein, when the armature is located between the initial position and a position close to the intermediate position, the second spring does not exert any force on the armature, and wherein a restoring force is exerted on the armature by the second spring when the armature is located between this position close to the intermediate position and the end position.

9. Contactor according to claim 8, characterized in that the second spring is harder than the first spring.

10. Contactor according to claim 1, characterised in that the first spring and the second spring are designed as spiral springs and are arranged concentrically to one another.

11. Contactor according to claim 1, characterized in that additional electrical resistors are linked with connectors of the secondary contacts in order to limit the intensity of current in an electrical circuit closed by the secondary contacts.

12. Contactor according to claim 1, characterized in that there is also an electronic system for turning on and turning off the precharging coil and pick-up coil, and for measuring and monitoring a current flowing through the secondary contacts.

13. Contactor according to claim 12, characterized in that the pick-up coil, if the intensity of current measured by the electronic system upon the switch-on procedure in the second switch position falls below a first threshold value, is switched on by the electronic system in addition to the precharging coil for a certain period of time, such that the armature moves from the intermediate position to the end position, wherein the precharging coil, if the intensity of current measured by the electronic system in the second switch position exceeds a second threshold value for a certain period of time, is switched off by the electronic system, such that the armature is moved by the restoring force into the initial position.

14. Contactor according to claim 1, characterized in that the main contacts and the secondary contacts are essentially arranged side by side in one plane, such that it is aligned in a manner perpendicular to the direction of movement of the armature.

15. Contactor according to claim 1, further comprising a contact bridge support, on which the main contact bridges and the secondary contact bridges are arranged, wherein the contact bridge support is connected with the armature.

16. Contactor according to claim 15, characterized in that the main contact bridges and the secondary contact bridges are spring loaded on the contact bridge support using contact pressure springs.

17. Contactor according to claim 16, characterized in that the contact pressure springs of the secondary contact bridges are longer than the contact pressure springs of the main contact bridges, wherein the distance between the secondary contacts and the secondary contact bridges in the first switch position is greater than the distance between the main contacts and the main contact bridges.

18. Contactor according to claim 1, characterized in that main contacts and secondary contacts are arranged in the area of a common arc control device.

19. Contactor of claim 18, characterized in that the arc control device comprises a control area with several arc interruption plates arranged in layers.

20. Contactor of claim 19, characterized in that the control area is filled with a protective gas.

21. Contactor according to claim 1, characterized in that the contactor is designed with two poles, and comprises four main contacts along with four secondary contacts.
